(19) United States
(12) Patent Application Publication
(10) Pub. No.: US 2017/0169482 A1
(43) Pub. Date: Jun. 15, 2017

(54) CALCULATION OF REACH AND FREQUENCY BASED ON RELATIVE LEVELS OF EXPOSURE ACROSS RESPONDENTS BY MEDIA CHANNELS CONTAINED IN SURVEY DATA

(71) Applicant: Richard C. Dodson, Cornwall (GB)

(72) Inventor: Richard C. Dodson, Cornwall (GB)

(21) Appl. No.: 15/364,647

(22) Filed: Nov. 30, 2016

Related U.S. Application Data
(60) Provisional application No. 62/264,977, filed on Dec. 9, 2015.

(51) Int. Cl. G06Q 30/02

(52) U.S. Cl. CPC G06Q 30/0276; G06Q 30/0201

(57) ABSTRACT

Media consumption survey data is calibrated to provide cross-media reach and frequency measures. Survey data is received that represents respondents' amount of consumption of respective types of media per measurement time period. For each respondent and each medium a respective probability is calculated. The probability is indicative of a likelihood that each respondent consumed a respective unit of the medium in question. The units of media are measured in time spent by the respondents. The probabilities for each medium are summed and calibrated to produce adjusted probabilities. The adjusted probabilities are used to calculate reach and frequency for a media-buying plan.

### CROSS-REFERENCE TO RELATED APPLICATION

This application claims the benefit of co-pending U.S. provisional patent application No. 62/264,977, filed Dec. 9, 2015; which provisional application is incorporated herein by reference.

### BACKGROUND

Many new types of media have developed over the last several decades. Audience measuring techniques for such media have also been developed. However, the different types of audience measures available for the various existing types of media do not provide ready comparison of the reach and frequency for advertising on the various media types. It is therefore difficult to perform media planning for advertising campaigns across media types.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, which illustrate preferred and exemplary embodiments and which are not necessarily drawn to scale, wherein:

FIG. 1 is a block diagram that illustrates a computer system provided in accordance with aspects of the present invention.

FIG. 2 is a flow chart that illustrates a process that may be performed in accordance with aspects of the present invention.

### DETAILED DESCRIPTION

In general, and for the purpose of introducing concepts of embodiments of the present invention, surveys of media consumption by type of media are translated into respondent-specific probabilities for consumption of an average unit of each type of medium. The probabilities are calibrated such that they sum to a value (hereinafter, “The Calibration Value”) equal to a determined calibration percent of the value of those respondents with any exposure to the medium in the measured time period but with an upper limit of 1% of the total population. Where a survey has weighted the respondents to reflect some given population then the adjustment should be made using the weighted totals. Reach and frequency can be calculated using the calibrated probabilities. As an example, and without limiting the scope of the invention, the determined calibration percent may be 2% in some embodiments. In other non-limiting examples, the determined calibration percentage may be a percentage in the range 1.5% to 2.5%, inclusive.

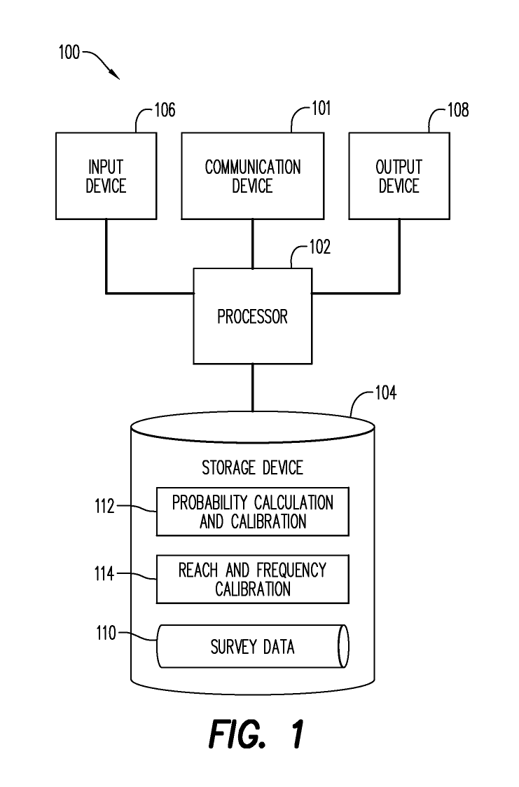

FIG. 1 is a block diagram that illustrates a computer system 100 provided in accordance with aspects of the present invention.

Referring now to FIG. 1, the computer system 100 may be constituted by standard components in terms of its hardware and architecture but may be controlled by software to cause it to function as described herein. For example, the computer system 100 may be or may resemble a personal computer.

The computer system 100 may include a computer processor 102 operatively coupled to a communication device 101, a storage device 104, an input device 106 and an output device 108. The communication device 101, the storage device 104, the input device 106 and the output device 108 may be in communication with the processor 102.

The computer processor 102 may be constituted by one or more processors. Processor 102 operates to execute processor-executable steps, contained in program instructions described below, so as to control the computer system 100 to provide desired functionality.

Communication device 101 may be used to facilitate communication with, for example, other devices (such as sources of data to be analyzed in accordance with aspects of the invention).

Input device 106 may comprise one or more of any type of peripheral device typically used to input data into a computer. For example, the input device 106 may include a keyboard and a mouse. Output device 108 may comprise, for example, a display and/or a printer.

Storage device 104 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 104 may store a data set 110, which may be data reflecting responses to a survey conducted relating to survey respondents' consumption of various types of media, as described in more detail below. Moreover, the storage device 104 may store one or more programs for controlling processor 102. The programs comprise program instructions (which may be referred to as computer readable program code means) that contain processor-executable process steps of the computer system 100, executed by the processor 102 to cause the computer system 100 to function as described herein so as to implement aspects of the invention.

The programs may include one or more conventional operating systems (not shown) that control the processor 102 so as to manage and coordinate activities and sharing of resources in the computer system 100, and to serve as a host for application programs (described below) that run on the computer system 100.

The storage device 104 may store, for example, a program 112 for calculating and calibrating probabilities related to respondents' media consumption. Functionality provided by the program 112 will be described in more detail below.

Further, the storage device 104 may store a program 114 to generate estimates of reach and frequency from planned media buying campaigns, based on calibrated probabilities provided by the probability generating program 112.

As indicated at 115, the programs 112 and 114 are executed by processor 102.

The storage device 104 may also store, and the computer system 100 may also execute, other programs, which are not shown. For example, such programs may include one or more data communication programs, database management programs, device drivers, etc.

In addition, the storage device 104 may store one or more additional databases (not shown) that may be required for operation of the computer system 100. Such databases, for example, may store data that represents the output of either or both of programs 112 and 114.

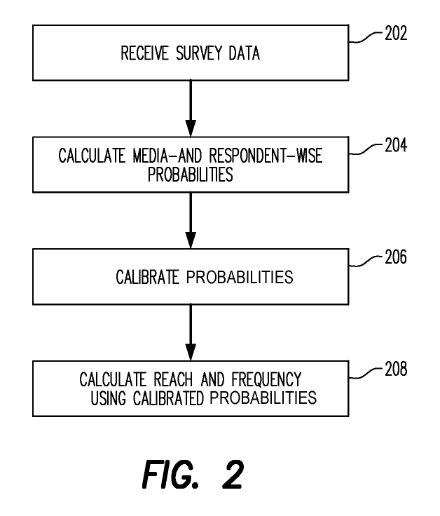

FIG. 2 is a flow chart that illustrates a process that may be performed in accordance with aspects of the present invention.

At 202 in FIG. 2, the computer system 100 may receive data from one or more data sources (not shown). The data received at block 202 may represent results of one or more surveys conducted to determine or estimate the media consumption habits of the survey respondents. The respondents may have been selected so as to constitute a representative sampling of a media market. In some embodiments, the media market in question may be defined as a particular political entity such as a sovereign country (e.g., the United States, the United Kingdom, France, Germany, and/or one or more European or non-European countries).

In some embodiments the question or questions asked in the survey may include a question such as, “How many hours did you spend last week watching television?” The survey may include other similar or analogous questions relating to the respondents' media consumption habits relating to media other than television or television subcategories. The other media may include, but are not necessarily limited to, radio, printed publications, social media platforms via various devices, gaming consoles, use of a mobile phone, traveling in a car, use of various forms of mass transit, or walking, etc. Examples of other questions include, “How many hours did you spend last week reading newspapers?” “How many hours last week did you spend listening to the radio between 6:00 a.m. and noon?” The distribution of media exposure or consumption across respondents need not necessarily be derived from the amount of time spent consuming or engaging with a media. Any value for engagement or consumption can be used, for example (but not necessarily limited to) the number of visits to a movie theater, the number of rides taken on a mass-transit vehicle such as a subway or a bus or a taxicab, or the number of issues of a magazine or newspaper read, or the number of times an ad was activated on the Internet. For the balance of this document, the amount of time spent is used for exemplary purposes only.

Table 1, set forth below, presents a simplified, limited-scope example of simulated television-watching data that may be obtained from respondents. The first column contains simple numeric identifiers for individual respondents. (In a practical embodiment, the number of respondents for which survey data may be collected may be much greater than the ten respondents indicated in this simulated data example.) The second column contains their response as to how many hours of television viewing they view during a week's time. Thus, the first two columns represent time spent data obtained via a (notional) survey.

The probability that is indicated in the third column is obtained by adjusting the corresponding figure in the second column by a factor of 4/(7/96). This provides a probability for the average quarter hour in the week. (The adjustment factor reflects, 4 quarter-hours per hour, 24 hours per day, seven days per week.) It will be noted that this adjustment is designed to produce values that are less than 1, and thus may be considered to be probabilities. Analogous adjustments may be made to data that represents respondents' rates of consumption of other types of media. With respect to the simulated probabilities indicated in Table 1, each probability may be represented by the term Pᵢ, where i is an index by respondent. Where survey data is collected for more than one type of medium, the resulting probabilities may be calculated so as to be proportional to “time spent” answers and may be represented by the term Pᵢⱼ, with the additional index j representing a respective type of media. The calculation of these probabilities is represented by block 204 in FIG. 2.

TABLE 1

| | Hrs/Wk | ¼ hr prob |
|---|---|---|
| 1 | 5 | 0.02976 |
| 2 | 10 | 0.05952 |
| 3 | 15 | 0.08929 |
| 4 | 20 | 0.11905 |
| 5 | 25 | 0.14881 |
| 6 | 30 | 0.17857 |
| 7 | 35 | 0.20833 |
| 8 | 40 | 0.23810 |
| 9 | 0 | 0 |
| 10 | 0 | 0 |

To support a desired calibration of the probabilities (in this case referring only to the TV-related simulated data), the Pᵢ may be summed as follows to produce the factor N.

ΣPᵢ=N (Eq. 1)

A goal of the desired calibration is to adjust N so that the adjusted summation of probabilities equals The Calibration Value. To provide this result, the probabilities Pᵢ are to be calibrated such that:

ΣPᵢ=α (Eq. 2)

This may be done by taking the original P, and adjusting them to obtain adjusted probabilities PAᵢ as follows

PAᵢ=(α/N)*Pᵢ (Eq. 3)

In the above formula, α (or in alternative notation, αⱼ) is The Calibration Value.

It will be noted that in the simulated TV watching data shown in Table 1, eight out of ten had a “positive response” (i.e., two out of ten said they watched no TV) so the proportion of the survey population with a positive response is 80%. This calibration of the probabilities is represented by block 206 in FIG. 2.

In a small number of situations, it may occur that the calibration/adjustment may lead to values of one or more of the PAᵢ that are greater than 1.0. In such a situation, a further adjustment can be made to limit the maximum to 1.0 and scale the rest of the probabilities to maintain The Calibration Value.

A more general version of Equation 3 may be written as

PAᵢⱼ=(αⱼ/Hⱼ)*Pᵢⱼ (Eq. 4)

According to block 208 in FIG. 2, the adjusted/calibrated probabilities may be used to calculate reach and/or frequency for a proposed media plan, including planned buys across various types of media. Customary calculation methods for reach and frequency can be applied to the adjusted/calibrated probabilities to arrive at the desired reach and frequency measures.

Once the probabilities have been determined they may be used by traditional methods to estimate the reach of a given level of GRPs (Gross Rating Points). The most commonly used method used is the binomial expansion. This uses the following formula to estimate the reach for, say G GRPs

Let ΣPᵢ=N for i-1, number of respondents

Let S=(G/100)/N

Then
Reach=(1-(1-(Pᵢ)^{S}) for i-1 to number of respondents

Other methods of calculating reach are also possible.

One advantage of the approaches described herein is that respondent-level probabilities can be generated from time spent data in a way that may allow for credible “reach” estimates to be produced.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

The flow chart and description thereof herein should not be understood to prescribe a fixed order of performing the method steps described therein. Rather the method steps may be performed in any order that is practicable.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claim, or in furtherance of teachings contained herein.

What is claimed is:

1. A method of calibrating media consumption survey data to provide cross-media reach and frequency measures, the method comprising:
receiving survey data representing respondents' amount of consumption of respective types of media per measurement time period;
calculating for each respondent and for each medium a respective probability Pᵢⱼ that said each respondent consumed a respective unit of said each medium; i being an index of respondents; j being an index of media types; said units of media being measured in time spent by the respondents;
summing the probabilities for each medium to produce a respective factor Nⱼ;
calibrating the probabilities for each medium to produce adjusted probabilities PAᵢⱼ according to the formula
PAᵢⱼ=(αⱼ/Nⱼ)*Pᵢⱼ,
where αⱼ=The Calibration Value of the jth medium type; and
using the adjusted probabilities PAᵢⱼ to calculate reach and frequency for a media-buying plan.

2. The method of claim 1, wherein the media types include two or more of (a) television; (b) radio; (c) printed publications; and (d) social media platforms.

3. The method of claim 2, wherein the media types include all of (a) television; (b) radio; (c) printed publications; and (d) social media platforms.

4. The method of claim 1, wherein said calculation of reach includes performing a binomial expansion according to a formula that has gross rating points as an input.

5. The method of claim 1, wherein the media buying plan includes buys for one or more of (a) television; (b) radio; (c) printed publications; and (d) social media platforms.

6. The method of claim 5, wherein the media buying plan includes buys for two or more of (a) television; (b) radio; (c) printed publications; and (d) social media platforms.

7. The method of claim 6, wherein the media buying plan includes buys for all of (a) television; (b) radio; (c) printed publications; and (d) social media platforms.

8. An apparatus for calibrating media consumption survey data to provide cross-media reach and frequency measures, the apparatus comprising:
a processor; and
a memory in communication with the processor, the memory storing program instructions, the processor operative with the program instructions to perform functions as follows:
receiving survey data representing respondents' amount of consumption of respective types of media per measurement time period;
calculating for each respondent and for each medium a respective probability Pᵢⱼ that said each respondent consumed a respective unit of said each medium; i being an index of respondents; j being an index of media types; said units of media being measured in time spent by the respondents;
summing the probabilities for each medium to produce a respective factor N₁;
calibrating the probabilities for each medium to produce adjusted probabilities Pᵢⱼ according to the formula
PAᵢⱼ=(αⱼ/Nⱼ)*Pᵢⱼ,
where αⱼ=The Calibration Value of the jth medium type; and
using the adjusted probabilities PAᵢⱼ to calculate reach and frequency for a media-buying plan.

9. The apparatus of claim 8, wherein the media types include two or more of (a) television; (b) radio; (c) printed publications; and (d) social media platforms.

10. The apparatus of claim 9, wherein the media types include all of (a) television;
(b) radio; (c) printed publications; and (d) social media platforms.

11. The apparatus of claim 8, wherein said calculation of reach includes performing a binomial expansion according to a formula that has gross rating points as an input.

12. The apparatus of claim 8, wherein the media buying plan includes buys for one or more of (a) television; (b) radio; (c) printed publications; and (d) social media platforms.

13. The apparatus of claim 12, wherein the media buying plan includes buys for two or more of (a) television; (b) radio; (c) printed publications; and (d) social media platforms.

14. The apparatus of claim 13, wherein the media buying plan includes buys for all of (a) television; (b) radio; (c) printed publications; and (d) social media platforms.

15. A non-transitory storage device, the storage device storing program instructions, the program instructions for programming a processor to perform functions as follows for calibrating media consumption survey data to provide cross-media reach and frequency measures:
receiving survey data representing respondents' amount of consumption of respective types of media per measurement time period;
calculating for each respondent and for each medium a respective probability Pᵢⱼ that said each respondent consumed a respective unit of said each medium; i being an index of respondents; j being an index of media types; said units of media being measured in time spent by the respondents;
summing the probabilities for each medium to produce a respective factor Nⱼ;
calibrating the probabilities for each medium to produce adjusted probabilities PAᵢⱼ according to the formula
PAᵢⱼ=(αⱼ/Nⱼ)*Pᵢⱼ,
where aⱼ=The Calibration Value of the jth medium type; and
using the adjusted probabilities PAᵢⱼ to calculate reach and frequency for a media-buying plan.

16. The storage device of claim 15, wherein the media types include two or more of (a) television; (b) radio; (c) printed publications; and (d) social media platforms.

17. The storage device of claim 16, wherein the media types include all of (a) television; (b) radio; (c) printed publications; and (d) social media platforms.

18. The storage device of claim 15, wherein said calculation of reach includes performing a binomial expansion according to a formula that has gross rating points as an input.

19. The storage device of claim 15, wherein the media buying plan includes buys for one or more of (a) television; (b) radio; (c) printed publications; and (d) social media platforms.

20. The storage device of claim 19, wherein the media buying plan includes buys for all of (a) television; (b) radio; (c) printed publications; and (d) social media platforms.
